(19) United States
(12) Patent Application Publication
(10) Pub. No.: US 2007/0158047 A1
(43) Pub. Date: Jul. 12, 2007

(54) Air conditioner for vehicle

(75) Inventor: Takuya Natsume, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/651,130

(22) Filed: Jan. 9, 2007

(30) Foreign Application Priority Data
Jan. 12, 2006 (JP) 2006-5327

(51) Int. Cl. B60H 3/00; B60H 1/00

(52) U.S. Cl. 165/43; 165/203; 165/42

(57) ABSTRACT

An air conditioner for a vehicle has an air conditioning unit, a first duct, and a second duct. The air conditioning unit has a unit case defining a first passage and a second passage and a heat exchanger for heating air flowing in the first passage and the second passage. The heat exchanger has a first core section and a second core section in communication with each other. The first core section is upstream of the second core section with respect to a flow of an internal fluid flowing in the heat exchanger. The heat exchanger is disposed such that the first core section is located in the first passage and the second core section is located in the second passage. Further, the first duct is in communication with the first passage and the second duct is in communication with the second passage. The first duct has heat loss greater than that of the second duct.

### CROSS REFERENCE TO RELATED APPLICATION

This application is based on Japanese Patent Application No. 2006-5327 filed on Jan. 12, 2006, the disclosure of which are incorporated herein by reference.

### FIELD OF THE INVENTION

The present invention relates to an air conditioner for a vehicle.

### BACKGROUND OF THE INVENTION

A vehicle air conditioner that can independently control the temperature of air to be supplied to different areas in a passenger compartment of the vehicle is known. By the air conditioner, for example, a right area and a left area of the passenger compartment, e.g., a passenger's seat area and a driver's seat area, can be independently air-conditioned.

In an air conditioner performing such an independent temperature control, an air conditioner unit is separated into a first passage space and a second passage space by a partition wall. The air conditioner unit having such a partition wall is for example disclosed in Japanese Unexamined Patent Publication No. 11-189024.

Conditions of air to be blown toward the different areas of the passenger compartment are independently or separately controlled in the first passage space and the second passage space, and then distributed to the respective areas through the ducts. However, the temperature of air is likely to change due to heat loss while flowing in the ducts. For example, in a case that the duct extending from the first passage space and the duct extending from the second passage space have different length for distributing the air toward the different areas, the heat loss will be different between the ducts.

### SUMMARY OF THE INVENTION

According to an aspect of the present invention, an air conditioner for a vehicle has an air conditioning unit including a unit case and a heat exchanger. The unit case defines a first passage and a second passage separated from each other and through which air flows. The heat exchanger performs heat exchange between an internal fluid flowing therein as a heat source and air flowing in the first passage and the second passage. The heat exchanger has a first core section and a second core section that are in communication with each other. The first core section is disposed upstream of the second core section with respect to a flow of the internal fluid.

The heat exchanger is disposed in the unit case such that the first core section is located in the first passage and the second core section is located in the second passage. The unit case defines a first opening at a downstream position of the first passage and a second opening at a downstream position of the second passage with respect to a flow of air. A first duct is coupled to the first opening and a second duct is coupled to the second opening.

The first duct has an air blowing outlet for blowing the air from the first passage toward a first area of a passenger compartment of the vehicle. Likewise, the second duct has an air blowing outlet for blowing the air from the second passage toward a second area of the passenger compartment. The first duct has a structure that causes more heat loss of air between its end coupled to the first opening and the air blowing outlet than that of the second duct.

In the above construction, the first core section is upstream of the second core section with respect to the flow of the internal fluid, the temperature of the internal fluid in the first core section is higher than that in the second core section. In other words, the air in the first passage is more heated than the air in the second passage. Further, the first duct, which causes more heat loss than the second duct, is in communication with the first passage. Accordingly, this construction compensates for the difference of heat loss between the first duct and the second duct.

For example, in a case that the air conditioning unit is disposed at a position offset from a centerline of the vehicle, the centerline extending in a front and rear direction of the vehicle, the first duct is arranged on a side opposite to the air conditioning unit and the second duct is arranged on the same side as the air conditioning unit. In this case, the first duct may be longer than the second duct. In other words, the length of the first duct from the end to the air blowing outlet may be greater than that of the second duct. Also in this case, the difference of heat loss due to the difference of the length will be compensated.

Accordingly, the independent air control operation can be efficiently performed even when the ducts have the different heat loss. Also, the above construction is effective when a target air temperature is high. For example, in a maximum heating operation, the temperature difference between the air blown from the first duct and the air blown from the second duct due to the difference of the heat loss is effectively reduced.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic view for showing general arrangements of ducts and an air conditioning unit of an air conditioner for a vehicle according to a first embodiment of the present invention;

FIG. 2 is a schematically perspective view of a vehicle having the air conditioner according to the first embodiment;

FIG. 3 is a schematic cross-sectional view of the air conditioning unit according to the first embodiment;

FIG. 4 is a schematic cross-sectional view of the air conditioning unit taken along a line IV-IV in FIG. 3;

FIG. 5 is a plan view of a heater core of the air conditioning unit, as an example, according to the first embodiment;

FIG. 6 is a plan view of a heater core of the air conditioning unit, as another example, according to the first embodiment;

FIG. 7 is a flowchart of a control operation of an air conditioner according to a second embodiment of the present invention; and

FIG. 8 is a flowchart of a control operation of an air conditioner according to a third embodiment of the present invention.

### DETAILED DESCRIPTION OF EXAMPLE EMBODIMENTS

### First Embodiment

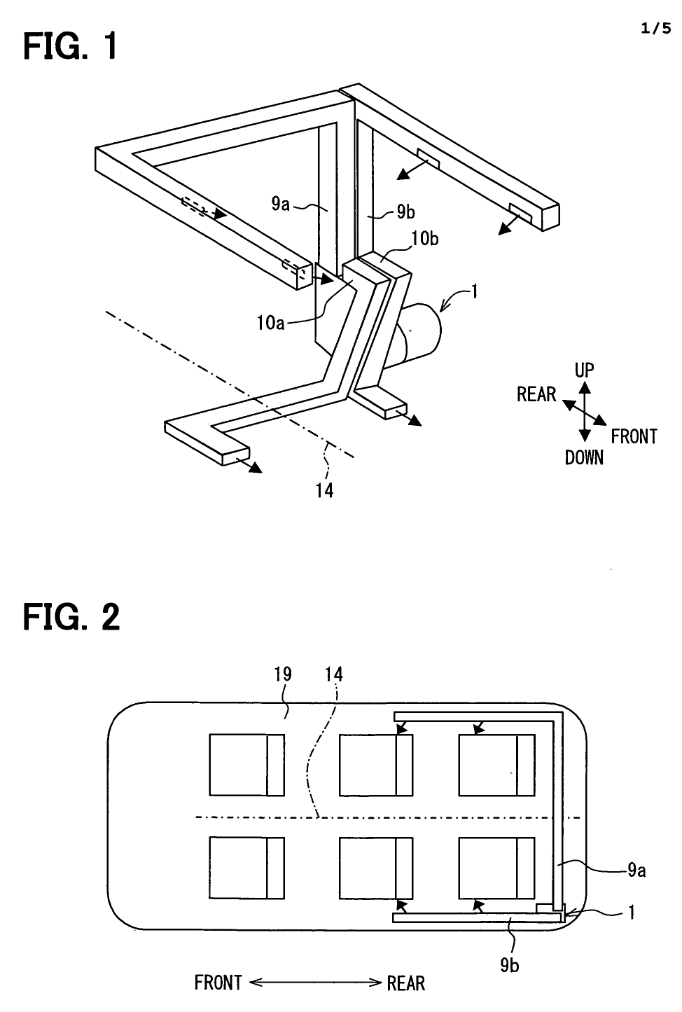

A first embodiment of an air conditioner of the present invention will be described with reference to FIGS. 1 to 6. The air conditioner is for example employed to a vehicle such as automobiles for private use and business use. The air conditioner can perform an automatic air-conditioning operation and air-conditioning operations according to a user's manual operation. Further, the air conditioner can independently or respectively control the temperatures of air to be blown toward different areas of the passenger compartment.

As shown in FIG. 1, the air conditioner has an air conditioning unit 1 and ducts 9a, 9b, 10a, 10b for distributing air conditioned in the air conditioning unit 1 into the passenger compartment 19. The air conditioning unit 1 is for example used as a rear air conditioning unit. In this case, the air conditioning unit 1 is arranged at a position offset or separated from a centerline 14 of the vehicle that extends in a vehicle front and rear direction.

Moreover, the air conditioning unit 1 is arranged in a space defined between an interior panel facing the passenger compartment 19 and an outer panel of a vehicle body on one of a left side and a right side of the vehicle. For example, the air conditioning unit 1 is arranged in a space defined by a side trim of the vehicle. In an example of FIG. 2, the air conditioning unit 1 is arranged in the space defined by a right trim.

The ducts 9a, 9b, 10a, 10b are arranged to distribute the air from the air conditioning unit 1 to the respective areas of the passenger compartment. The ducts 9a, 9b, 10a, 10b have different length. The ducts 9a, 9b, 10a, 10b are for example made of a resin such as polypropylene.

A first duct 9a and a second duct 9b project from a top wall of the air conditioning unit 1 and extend upward along a left rear pillar that extends from the left trim. Then, the first duct 9a and the second duct 9b bend in different directions.

The first duct 9a further extends to a right side of the vehicle and then, bends in a front direction and extends along a right upper portion of the vehicle. For example, the first duct 9a extends along spaces defined between a ceiling member and outer panel members of the vehicle.

On the other hand, the second duct 9b bends in the front direction and extends along a left upper portion of the vehicle. Similar to the first duct 9a, the second duct 9b extends through a space defined between the ceiling member and an outer panel member of the vehicle. As such, the first duct 9a is longer than the second duct 9b.

Further, the first duct 9a and the second duct 9b have air blowing outlet for blowing air toward upper areas of rear passenger seats. In the example of FIG. 2, each of the first duct 9a and the second duct 9b has the air blowing outlets at positions corresponding to the rear passenger seats in second and third rows.

A third duct 10a and a fourth duct 10b extend downward from the top wall of the air conditioning unit 10, and then separate to the right side and the left side. For example, the third duct 10a extends to the right side along a rear lower portion of the vehicle after separating from the fourth duct 10b and further extends toward right rear seats. The fourth duct 10b extends along a left lower portion of the vehicle toward left rear seats. As such, the third duct 10a is longer than the fourth duct 10b.

The third duct 10a and the fourth duct 10b can be arranged under a floor of the vehicle. The third duct 10a and the fourth duct 10b have air blowing outlets for blowing air toward lower areas of the rear passenger seats.

In the air conditioning unit 1, a first passage space 31a and a second passage space 31b are defined. The temperature of air flowing in the first passage space 31a and the temperature of air flowing in the second passage space 31b are independently controlled. The first duct 9a and the third duct 10a are in communication with the first passage space 31a. The second duct 9b and the fourth duct 10b are in communication with the second passage space 31b.

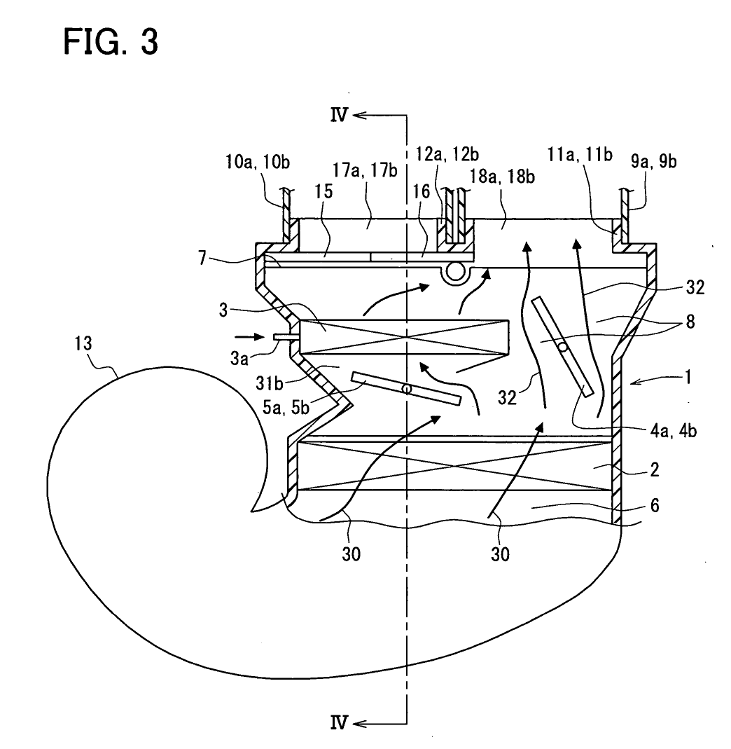

As shown in FIG. 3, the air conditioning unit 1 has a unit case. The air conditioning unit 1 mainly has a blower section 13 and an air conditioning section in the unit case. The air conditioning section is located downstream of the blower section 13 with respect to the flow of air.

The unit case is constructed by coupling plural case members made of a resin such as polypropylene. The case members are integrated by fastening means such as metal springs and screws.

The blower section 13 is in communication with the air conditioning section through an air passage 6. The blower section 13 has a blower for sucking air from a rear area of the passenger compartment 19 and blowing the air into the air passage 6.

The blower has a centrifugal multi-blade fan and a motor for driving the fan. The fan is enclosed in a scroll casing portion communicating with the air passage 6. Although not illustrated, a suction port of the blower is in communication with a suction opening that is open in the rear area of the passenger compartment 19 through a suction duct. The suction opening is for example formed on a package tray that is provided behind the rear passenger seats.

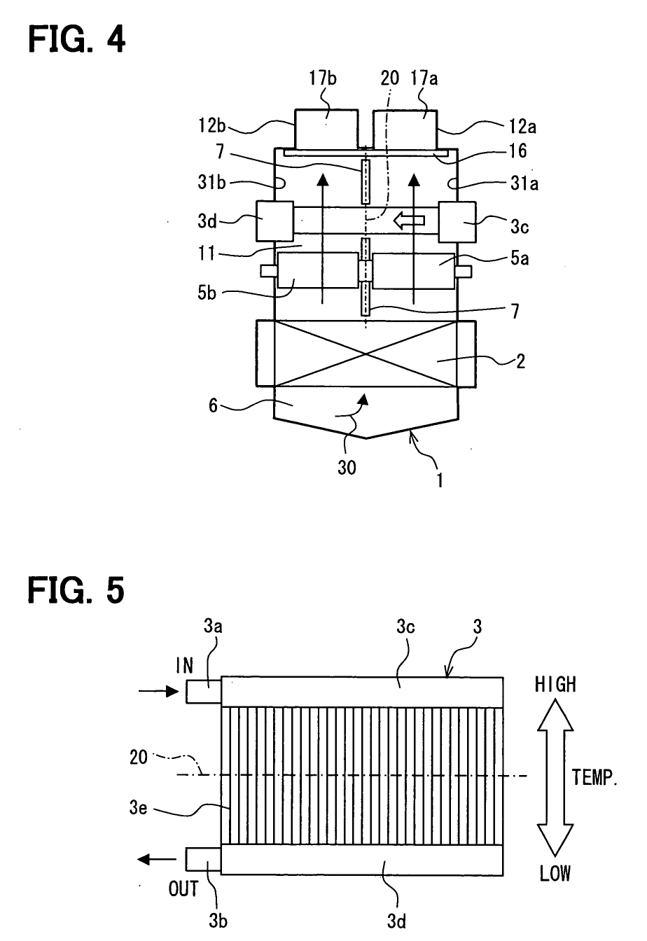

The air conditioning section has an evaporator 2, a heater core 3, first and second cool air adjusting doors 4a, 4b, and first and second heating air adjusting doors 5a, 5b. The evaporator 2 is disposed entirely across the air passage 6, as shown in FIGS. 3 and 4.

The evaporator 2 performs heat exchange between air 30 flowing from the air passage 6 and an internal fluid flowing inside of the evaporator 2 (e.g., low temperature and low pressure refrigerant having been decompressed by an expansion valve of a refrigerating cycle). Thus, the air 30 is cooled with evaporation of the refrigerant.

The air conditioning section further has a partition wall 7 for separating a space downstream of the evaporator 2 into the first passage space 31a and the second passage space 31b, as shown in FIG. 4. The partition wall 27 is a plate member made of a resin such as polypropylene.

The partition wall 27 extends from an air discharge side of the evaporator 2 from which the air 30 is discharged toward a downstream position of the unit case. The partition wall 27 is fixed to the unit case. For example, a peripheral portion of the partition wall 27 is interposed between the case members, which are integrated together.

The heater core 3 is disposed downstream of the evaporator 2 with respect to a flow of air. The heater core 3 performs heat exchange between the air cooled by the evaporator 2 and an internal fluid flowing therein, thereby to heat the air.

The heater core 3 intersects the first passage space 31a and the second passage space 31b. Also, the heater core 3 is disposed partly across each of the first passage space 31a and the second passage space 31b, as shown in FIG. 3. Thus, first and second cool air passages 8 are formed in parallel to the heater core 3 in the first and second passage space 31a, 31b, respectively. The first and second cool air passages 8 permit cool air 32 to bypass the heater core 3.

As shown in FIG. 5, the heater core 3 has a core part 3e, a first tank 3c and a second tank 3d. The core part 3e has tubes through which the internal fluid flows. The first tank 3c is disposed at a first end of the core part 3e and in communication with the tubes. The second tank 3d is disposed at a second end of the core part 3e and in communication with the tubes. Further, the first tank 3c is provided with an inlet 3a through which the internal fluid enters the heater core 3. The second tank 3d is provided with an outlet 3b through which the internal fluid is discharged from the heater core 3.

The heater core 3 is arranged such that a first core section including the first tank 3c and an upstream section of the core part 3e with respect to the flow of the internal fluid (an upper half section in FIG. 5) is located in the first passage space 31a and a second core section including the second tank 3d and a downstream section of the core part 3e (a lower half section in FIG. 5) is located in the second passage space 31b.

In FIG. 5, a dashed line 20 denotes an imaginary centerline of the heater core 3 extending in a direction perpendicular to a flow direction of the internal fluid in the core part 3e. The dashed line 20 corresponds to a boundary between the first core section and the second core section. The heater core 3 and the partition wall 7 have a positional relationship such that the partition wall 7 extends on both an upstream side and a downstream side of the heater core 3 at a position corresponding to the centerline 20.

Here, the internal fluid of the heater core 3 is for example a cooling water of an engine. The heater core 3 is in communication with a water jacket of the engine through a heater core circuit (not shown). For example, the cooling water is forcibly circulated by a water pump. The cooling water flows in the first tank 3c from the inlet 3a. The cooling water is collected in the second tank 3d after passing through the tubes and then discharged from the outlet 3b.

The cooling water receives heat from the engine while passing through the water jacket. The heated cooling water enters the first tank 3c from the inlet 3a and is cooled by the air while passing through the core part 3e. Thus, the temperature of the cooling water reduces toward the second tank 3d. Accordingly, the air passing through the first core section of the heater core 3 is more heated than air passing through the second core section of the heater core 3. In other words, the air flowing in the first passage space 31a is more heated than the air flowing in the second passage space 31b. The air in the first passage space 31a, which has the higher temperature, is introduced to the first duct 9a and the third duct 10a.

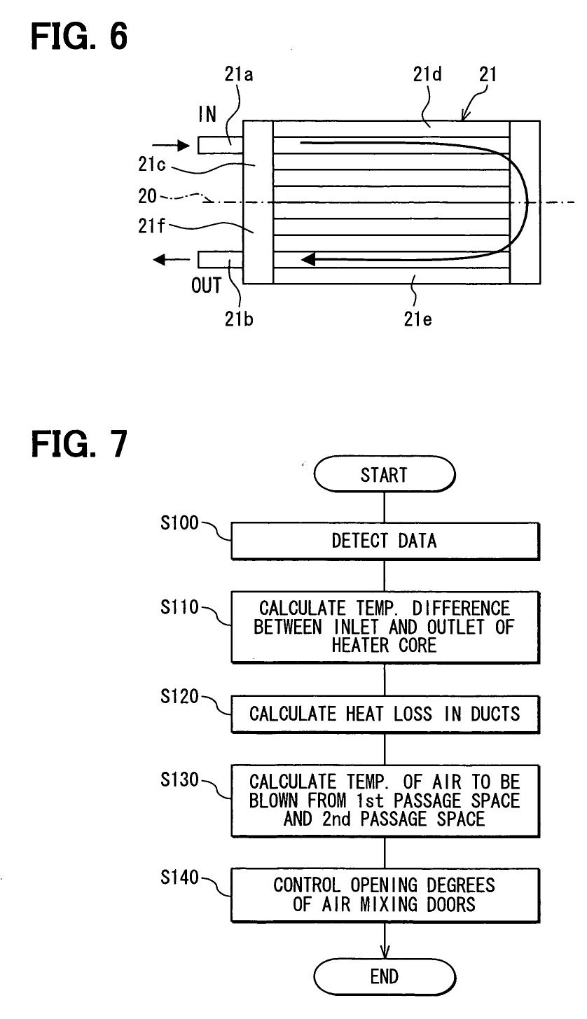

In the example of FIG. 5, the heater core 3 is a full-path type heat exchanger in which the internal fluid flows in one direction. However, the heater core 3 is not limited to the full-path type. For example, a U-turn type heat exchanger shown in FIG. 6 can be used in place of the heater core 3 shown in FIG. 5.

The heater core 21 has a first core part (first core section) 21d and a second core part (second core section) 21e. The internal fluid enters a first tank 21c from an inlet 21a and flows in the first core part 21d. Then, the internal fluid makes U-turn, i.e., turns in an opposite direction and flows in the second core part 21e. Thereafter, the internal fluid is collected in a second tank 21f and discharged from an outlet 21b.

In the heater core 21, the temperature of the internal fluid flowing in the first core part 21d is higher than that of the internal fluid flowing in the second core part 21e. Therefore, the heater core 21 is disposed in the unit case such that the partition wall 7 is located at a position corresponding to the imaginary centerline 20 that coincides with a boundary between the first core part 21d and the second core part 21e. In other words, the heater core 21 is disposed such that the first core part 21d is located in the first passage space 31a and the second core part 21e is located in the second passage space 31b.

Further, the first cool air adjusting door 4a and the first heating air adjusting door 5a are disposed in the first passage space 31a as first air mixing doors. The second cool air adjusting door 4b and the second heating air adjusting door 5b are disposed in the first passage space 31b as second air mixing doors. The first and second cool air adjusting doors 4a, 4b and the first and second heating air adjusting doors 5a, 5b are for example butterfly doors each having two door plates extending from its rotation axis in different directions.

Specifically, the first heating air adjusting door 5a is disposed upstream of the first core section of the heater core 3 in the first passage space 31a for adjusting a ratio of the volume of air to be introduced to the first core section of the heater core 3 to the volume of air 32 bypassing the heater core 3 through the first cool air passage 8. The first cool air adjusting door 4a is disposed in the first cool air passage 8 for adjusting the volume of cool air 32 flowing in the first cool air passage 8.

Likewise, the second heating air adjusting door 5b is disposed upstream of the second core section of the heater core 3 in the second passage space 31b for adjusting a ratio of the volume of air to be introduced to the second core section of the heater core 3 to the volume of air 32 bypassing the heater core 3 through the second cool air passage 8. The second cool air adjusting door 5b is disposed in the second cool air passage 8 for adjusting the volume of cool air 32 flowing in the second cool air passage 8.

Opening degrees of the cool air adjusting doors 4a, 4b are respectively controlled by a control unit. Likewise, opening degrees of the heating air adjusting doors 5a, 5b are respectively controlled by the control unit. As such, the temperature of the air blown from the first passage space 31a and the temperature of the air blown from the second passage space 31b are independently or respectively controlled.

The cool air adjusting doors 4a, 4b and the heating air adjusting doors 5a, 5b are not limited to the butterfly doors, but can be other type of doors such as sliding doors that are operated in a sliding manner or one-side holding type doors each of which has a single door plate rotatable about its one end.

At the downstream position of the air conditioning unit, a first foot opening 17a, a second foot opening 17b, a first face opening 18a, and a second face opening 18b are formed. Specifically, the first foot opening 17a and the first face opening 18a are formed at the downstream position of the first passage space 31a with respect to the flow of air. The second foot opening 17b and the second face opening 18b are formed at the downstream position of the second air passage space 31b with respect to the flow of air.

The first face opening 18a is defined by a first tubular portion 11a of the upper wall of the unit case. The first duct 9a is coupled to the first tubular portion 11a. As such, the first duct 9a is in communication with the first passage space 31a. The second face opening 18b is defined by a second tubular portion 11 of the upper wall of the unit case. The second duct 9b is coupled to the second tubular portion 11b. As such, the second duct 9b is in communication with the second passage space 31b.

Likewise, the first foot opening 17a is defined by a third tubular portion 12a of the upper wall of the unit case. The third duct 10a is coupled to the third tubular portion 12a. As such, the third duct 10a is in communication with the first passage space 31a. The second foot opening 17b is defined by a fourth tubular portion 12b of the upper wall of the unit case. The fourth duct 10b is coupled to the fourth tubular portion 12b. As such, the fourth duct 10b is in communication with the second passage space 31b.

The first foot opening 17a is located next to the first face opening 18a. The first foot opening 17a is on a side closer to the heater core 3 than the first face opening 18a. Likewise, the second foot opening 17b is located next to the second face opening 18b. The second foot opening 17b is located on a side closer to the heater core 3 than the second face opening 18b.

Also, the air conditioning section have foot opening doors 15 at positions adjacent to the first and second foot openings 17a 17b for opening and closing the first and second foot openings 17a, 17b, respectively. The foot opening doors 15 are operated to positions where the first and second foot openings 17a, 17b are fully open, fully closed, or open only half, respectively.

Further, face opening doors 16 are provided adjacent to the first and second face openings 18a, 18b for opening and closing the first and second face openings 18a, 18b, respectively. The face opening door 16 are operated to positions where the first and second face openings 18a, 18b are fully open, fully closed, or open only half, respectively.

In an example of FIG. 3, the foot opening doors 15 and the face opening doors 16 are slide doors. However, the foot opening doors 15 and the face opening doors 16 are not limited to the slide doors, but can be other doors as long as there do not require large operation spaces in the air flow direction. For example, the foot opening doors 15 and the face opening doors 16 can be winding film doors, flexible slide doors, lamination slide doors, or the like.

Further, the unit case forms first and second air mixing chambers in the first and second passage spaces 31a, 31b for mixing the cool air 32 and heated air having passed through the heater core 3, respectively. The first and second air mixing chambers are defined directly downstream of the first and second core sections of the heater core 3, respectively.

In a bi-level mode, the cool air flowing through the first cool air passage 8 is directed to the first air mixing chamber by the first cool air adjusting door 4a and is mixed with the air heated by the first section of the heater core 3. Likewise, the cool air flowing through the second cool air passage 8 is directed to the second air mixing chamber by the second cool air adjusting door 4b and is mixed with the air heated by the second section of the heater core 3.

Next, operations of the air conditioning section in a face mode and a foot mode will be described. First, in the face mode, the foot opening doors 15 and the face opening doors 16 are moved to the positions where the foot opening doors 15 and the face opening doors 16 cover the first and second foot openings 17a, 17b, and the first and second face openings 18a are fully open, as shown in FIG. 3.

Also, the cool air adjusting doors 4a, 4b and the heating air adjusting doors 5a, 5b are controlled to respectively appropriate opening degrees such that the air to be blown into the first duct 9a from the first passage space 31a and the air to be blown into the second duct 9b from the second passage space 31b have respective target temperatures.

Further, in a maximum cooling operation, the first and second cool air adjusting doors 4a, 4b are operated to positions where the first and second air passages 8 are fully open. Also, the first and second heating air adjusting doors 5a, 5b are operated to positions where the heating air passages to the heater core 3 are fully closed.

In the foot mode, the foot opening doors 15 and the face opening doors 16 are operated to the positions where the foot opening doors 15 and the face opening doors 16 fully cover the first and second face openings 18a, 18b, and the first and second foot openings 17a, 17b are fully open. Further, the cool air adjusting doors 4a, 4b and the heating air adjusting doors 5a, 5b are controlled to respectively appropriate opening degrees such that the air to be blown into the third duct 10a from the first passage space 31a and the air to be blown into the fourth duct 10b from the second passage space 31b have respective target temperatures.

Also, in a maximum heating operation, the first and second heating air adjusting doors 5a, 5b are operated to positions where the heating air passages are fully open. The cool air adjusting doors 4a, 4b are operated to positions where the first and second cool air passages 8 are fully closed. Thus, the air 30 is fully introduced to the heater core 3.

In the heater core 3, the air passing through the first core section is more heated than the air passing through the second core section. Namely, the air of the first passage space 31a is more heated than the air of the second passage space 31b. The control unit performs independent control operation in consideration of the temperature difference created by the arrangement of the heater core 3 and the difference of heat loss in the ducts 9a, 9b, 10a, 10b.

Incidentally, the ducts 9a, 9b, 10a, 10b have the different length. Therefore, heat loss in the respective ducts 9a, 9b, 10a, 10b will be different. In the embodiment, the longer ducts 9a, 10a, which have the heat loss larger than that of the ducts 9b, 10b, are coupled to communicate with the first passage space 31a in which the first section of the heater core 3 is arranged.

Therefore, the difference of heat loss is compensated. The control operation is effectively performed in view of the temperature difference between the first passage space 31a and the second passage space 31b and the difference of the heat loss in the ducts 9a, 9b, 10a, 10b.

Especially, in the maximum heating operation, the heating air adjusting doors 5a, 5b are operated to the positions fully opening the heating air passages. If the heater core is arranged such that its left half section in FIG. 5 is located in one of the first and second passage spaces 31a, 31b and its right half section in FIG. 5 is located in the other of the first and second passage spaces 31a, 31b, it is difficult to create temperature difference between the air in the first passage space 31a and the air in the second passage space 31b. In this case, there will be a temperature difference between the air blown from the longer duct and the air blown from the shorter duct due to the difference of heat loss.

In the above embodiment, on the other hand, the air blown into the longer duct can be more heated than the air blown into the shorter duct even in the maximum heating operation, the temperature difference between the air blown from the longer duct and the air blown from the shorter duct due to the difference of the heat loss will be reduced.

In addition, the difference of heat loss in the ducts 9a, 9b, 10a, 10b can be further reduced or compensated by varying the amount of heat insulation of the respective ducts 9a, 9b, 10a, 10b. For example, the amount of heat insulating material provided on the respective ducts 9a, 9b, 10a, 10b can be varied, as necessary. Also, materials forming the ducts 9a, 9b, 10a, 10b can be varied so as to reduce the difference of heat loss.

### Second Embodiment

In a second embodiment, the air conditioning unit have the same structure as that of the first embodiment, but the first cool air adjusting door 4a and the first heating air adjusting door 5a as the first air mixing doors and the second cool air adjusting door 4b and the second heating air adjusting door 5b are controlled in the following manner. FIG. 7 shows a control operation for respectively controlling the opening degrees of the first air mixing doors 4a, 5a and the second air mixing doors 4b, 5b.

As shown in FIG. 7, when an operation of the air conditioner begins, the control unit starts the control operation. First, at a step S100, the control unit receives signals corresponding to various information such as the temperature of the cooling water, a flow rate of the cooling water (engine rotational speed), the temperature of the passenger compartment 19, and the volume of air (an operation level of blower), which are detected by various sensors.

Next, at a step S110, a temperature difference of the internal fluid between an inlet side and an outlet side of the heater core 3 is calculated based on the information detected in the step S100. Then, at a step S120, heat loss of each of the first to fourth ducts 9a, 9b, 10a, 10b is calculated. The step S120 can be performed at the same time as the step S110.

At a step S130, the temperature of the air to be blown into the first and third ducts 9a, 10a and the temperature of air to be blown into the second and fourth ducts 9b, 10b are calculated. Next, at a step S140, the opening degree of each the first air mixing doors 4a, 5a and the second air mixing doors 4b, 5b is adjusted such that the air blown toward the first and third ducts 9a, 10a and the air blown toward the second and fourth ducts 9b, 10b have respective temperatures calculated by the step S130.

Accordingly, the temperature of air blown into the first and third ducts 9a, 10a and the temperature of air blown into the second and fourth ducts 9b, 10b are calculated according to parameters, which affect to the temperature of air downstream of the heater core 3, such as the engine rotational speed, the temperature of the cooling water, the heat loss in the ducts, the lower operation level, and the like. Further, the opening degrees of the first air mixing doors 4a, 4b and the second air mixing doors 5a, 5b are controlled based on the calculated temperatures. Accordingly, the air conditioning operation can be effectively performed in consideration of the heating performance of the heater core 3.

### Third Embodiment

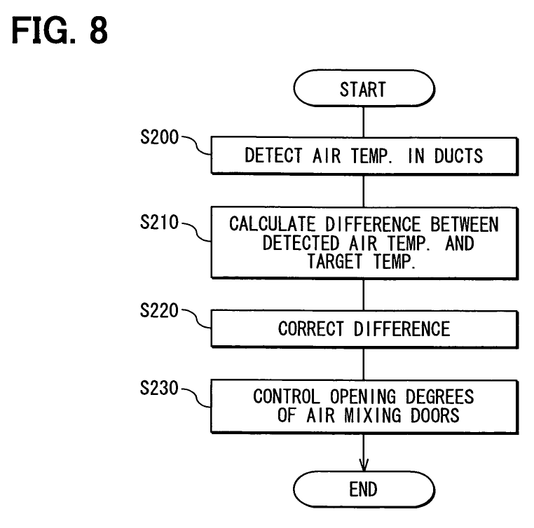

Next, a third embodiment will be described with reference to FIG. 8. In the third embodiment, the first air mixing doors 4a, 5a and the second air mixing doors 4b, 5b are controlled in the different manner. In the control operation of the third embodiment, at a step S200, the control unit receives signals corresponding to the temperature of the air flowing in each of the first to fourth ducts 9a, 9b, 10a, 10b detected by sensors.

Next, at a step S210, the control unit calculates the difference between each detected temperature and a target air temperature. At a step S220, it is determined how much the correction is required based on the difference calculated in the step S210. Then, at a step S230, the opening degree of each of the first air mixing doors 4a, 5a and the second air mixing doors 4b, 5b is controlled based on the correction determined at the step S220.

In the above control operation, the feedback control is performed by correcting the difference between the detected temperature of each duct and the target temperature. The opening degrees of the first and second air mixing doors 4a, 4b, 5a, 5b are controlled with changes of conditions such as the flow rate and the temperature of the cooling water in the heater core 3, the temperature of the passenger compartment 19, the volume of air and the like. Therefore, the air conditioning operation can be performed efficiently.

In the third embodiment, the temperature of each duct is detected by the sensor and the like. Instead, the temperature of the first air passage 31a and the temperature of the second air passage 31b can be detected at the respective downstream positions.

The exemplary embodiments of the present invention are described above. However, the present invention is not limited to the above embodiments, but may be implemented in other ways without departing from the spirit of the invention.

For example, in the embodiment illustrated in FIG. 2, the air conditioning unit 1 is arranged on the left side portion of the vehicle, the first and third ducts 9a, 10a are arranged to extend from the left side portion to the right side portion of the vehicle and the second and fourth ducts 9b, 10b are arranged on the left side portion. Alternatively, the air conditioning unit 1 can be arranged on the right side portion of the vehicle. In this case, the second and fourth ducts 9b, 10b are arranged on the same side as the air conditioning unit 1 and the first and third ducts 9a, 10a are arranged to extend from the right side portion to the left side portion.

In the embodiment illustrated in FIG. 2, the air conditioner is constructed such that the air conditioning operation is performed for the rear right area and the rear left area of the passenger compartment 19 independently. However, the air conditioner of the above embodiments can be employed to perform air conditioning operation for any different areas of the passenger compartment 19. For example, the air conditioner can be used to perform air conditioning operation for the front area and the rear area of the passenger compartment 19 independently.

The air conditioning unit 1 can be arranged at a different position. Also, the arrangement of the first to fourth ducts 9a, 9b, 10a, 10b is not limited to the left side portion and the right side portion of the vehicle shown in FIG. 2. The first to fourth ducts 9a, 9b, 10a, 10b can be arranged in a different manner as long as the air of the first passage space 31a and the air of the second passage space 31b are introduced into the longer ducts 9a, 10a and the shorter ducts 9b, 10b, respectively, and blown toward different areas in the passenger compartment 19.

Further, the passage spaces separated in the unit case are not limited to the first and second passage spaces 31a, 31b. The unit case can be separated into more than three passage spaces for performing independent control operation for more than three areas in the passenger compartment 19. Further, the numbers of the ducts are not limited to four. Also, the air conditioner is not limited to the rear air conditioner. Further, the position of the air conditioning unit 1 is not limited to the rear portion of the vehicle. For example, the air conditioner can be mounted at a front portion of the vehicle.

Furthermore, since the heat loss in the duct is generally affected by other causes such as its arrangement shape, passage flow area, layout in the vehicle, ambient temperature, and the like. Therefore, the use of air conditioning unit 1 is not limited to the combination with the ducts 9a, 9b, 10a, 10b having the different length. Ducts having larger heat loss are coupled to communicate with the first passage space 31a and the ducts having less heat loss are coupled to communicate with the second passage space 31b.

Also, the mounting position of the air conditioning unit 1 is not limited to the position offset from the centerline of the vehicle. The air conditioner can be used when the ducts have different heat loss due to limitations of design or layout in the vehicle, even when the air conditioning unit 1 is arranged on the substantially the centerline.

What is claimed is:

1. An air conditioner for a vehicle that defines a centerline extending in a vehicle front and rear direction, comprising:
an air conditioning unit disposed at a position offset from the centerline of the vehicle, the air conditioning unit having a unit case through which air flows and a heat exchanger disposed in the unit case for performing heat exchange between an internal fluid flowing therein as a heat source and the air, the unit case defining a first passage and a second passage separated from each other, the heat exchanger having a first core section and a second core section in communication with each other, the first core section disposed upstream of the second core section with respect to a flow of the internal fluid, the heat exchanger disposed such that the first core section is located in the first passage and the second core section is located in the second passage;
a first duct having an end coupled to the unit case and in communication with the first passage, the first duct further having an air blowing outlet for blowing air having passed through the first passage toward a first area of a passenger compartment of the vehicle; and
a second duct having an end coupled to the unit case and in communication with the second passage, the second duct further having an air blowing outlet for blowing air having passed through the second passage toward a second area of the passenger compartment, wherein a length of the second duct from the end to the air blowing outlet is less than that of the first duct.

2. The air conditioner according to claim 1, wherein
the vehicle has a first trim member on one of its right portion and its left portion and a second trim member on the other of the right portion and the left portion,
the air conditioning unit is disposed in a space defined by the first trim member,
the second duct is arranged on a side of the first trim member, and
the first duct extends from the air conditioning unit toward the second trim member.

3. The air conditioner according to claim 1, wherein
the first duct and the second duct have predetermined heat insulation, respectively, in consideration of a temperature difference between air blown from the air blowing outlet of the first duct and air blown from the air blowing outlet of the second duct.

4. The air conditioner according to claim 1, wherein
the air conditioning unit further has a first door in the first passage and a second door in the second passage, the air conditioner further comprising:
a control unit that calculates a temperature of air to be blown into the first duct and a temperature of air to be blown into the second duct based on information corresponding to at least one of a temperature of the internal fluid, a flow rate of the internal fluid, a temperature of the passenger compartment, and a volume of air flowing in the unit case, and determines opening degrees of the first door and the second door based on calculated temperatures.

5. The air conditioner according to claim 1, wherein
the air conditioning unit further has a first door in the first passage for adjusting air flowing in the first passage and a second door in the second passage for adjusting a volume of air flowing in the second passage, the air conditioner further comprising:
a control unit that controls opening degrees of the first door and the second door based on a temperature of the air flowing in the first duct and a temperature of the air flowing in the second duct, respectively.

6. The air conditioner according to claim 1, wherein
the heat exchanger has an inlet adjacent to the first core section for allowing the internal fluid to enter the first core section and an outlet adjacent to the second core section for allowing the internal fluid to flow out from the second core section.

7. An air conditioner for a vehicle comprising:
an air conditioning unit having a unit case and a heat exchanger for performing heat exchange between an internal fluid flowing therein as a heat source and air flowing in the unit case, the unit case defining a first passage and a second passage separated from each other, the heat exchanger having a first core section and a second core section in communication with each other, the first core section disposed upstream of the second core section with respect to a flow of the internal fluid, the heat exchanger disposed such that the first core section is located in the first passage and the second core section is located in the second passage, the unit case further defining a first opening at a downstream position of the first passage and a second opening at a downstream position of the second passage with respect to a flow of air;
a first duct coupled to the first opening and having an air blowing outlet for blowing air from the first passage space toward a first area of a passenger compartment of the vehicle; and
a second duct coupled to the second opening and having an air blowing outlet for blowing air from the second passage space toward a second area of the passenger compartment, wherein the first duct has a structure causing heat loss of air flowing therein greater than that of the second duct.

8. The air conditioner according to claim 7, wherein
the air conditioning unit is arranged at a position offset from a centerline of the vehicle, the centerline extending in a front and rear direction of the vehicle.
